(19) United States
(12) Patent Application Publication
(10) Pub. No.: US 2025/0192291 A1
(43) Pub. Date: Jun. 12, 2025

(54) HERMETICALLY SEALED BATTERY

(71) Applicant: Panasonic Energy Co., Ltd., Osaka (JP)

(72) Inventor: Shin HARAGUCHI, Hyogo (JP)

(21) Appl. No.: 18/845,320

(22) PCT Filed: Mar. 6, 2023
(86) PCT No.: PCT/JP2023/008311

§ 371 Date: Sep. 9, 2024

(30) Foreign Application Priority Data
Mar. 18, 2022 (JP) 2022-044503

(51) Int. Cl. H01M 50/159; H01M 50/107; H01M 50/15; H01M 50/342

(52) U.S. Cl. CPC H01M 50/159; H01M 50/107; H01M 50/15; H01M 50/3425

(57) ABSTRACT

Provided is a hermetically sealed battery comprising a sealing plate having improved adhesion strength between an Al-containing coating layer and a substrate containing Fe as a main component. The hermetically sealed battery comprises a bottomed cylindrical outer can having an opening and containing an electrode assembly and an electrolyte; and a sealing plate blocking the opening of the outer can, wherein the sealing plate has a substrate containing Fe as a main component, and an Al- and Si-containing coating layer formed on the battery inner surface of the substrate.

### TECHNICAL FIELD

The present disclosure relates to a hermetically sealed battery.

### BACKGROUND

Conventionally, in a hermetically sealed battery, an opening of a bottomed cylindrical exterior can which accommodates an electrode assembly and an electrolyte is sealed with a sealing plate, thereby ensuring sealability of the inside of the battery.

For the sealing plate, an Al material is generally used from the viewpoint of corrosion resistance against the electrolyte, but the Al material has a low melting point and low mechanical strength among metal materials, and thus has a problem of low pressure resistance strength when an internal pressure of the battery increases.

Therefore, a sealing plate in which a coating layer containing Al is formed by plating a surface of a base material containing Fe as a main component has been proposed (see, for example, Patent Literature 1). By using a sealing plate having a base material containing Fe as a main component and a coating layer containing Al formed on a surface of the base material, it has become possible to improve mechanical strength and a melting point while having corrosion resistance to an electrolyte.

### CITATION LIST

### Patent Literatures

Patent Literature 1: JP 50-73137 A

Patent Literature 2: JP 02-056849 A

Patent Literature 3: JP 2000-149884 A

### SUMMARY

However, since intermetallic bond between Fe and Al is weak, there is a problem that the adhesion strength between the base material containing Fe as a main component and the coating layer containing Al is low. When the adhesion strength is low, for example, when the sealing plate is pressed into a predetermined shape, an interface between the base material and the coating layer is cracked, or when cracking is more remarkable, the base material is exposed to the surface.

Therefore, an object of the present disclosure is to provide a hermetically sealed battery including a sealing plate in which adhesion strength between a base material containing Fe as a main component and a coating layer containing Al is improved.

A hermetically sealed battery according to the present disclosure includes: a bottomed cylindrical exterior can that has an opening and accommodates an electrode assembly and an electrolyte; and a sealing plate that closes the opening of the exterior can, in which the sealing plate includes a base material containing Fe as a main component and a coating layer containing Al and Si and formed on a battery inner surface of the base material.

According to the present disclosure, it is possible to provide the hermetically sealed battery including the sealing plate in which adhesion strength between the base material containing Fe as a main component and the coating layer containing Al is improved.

### BRIEF DESCRIPTION OF DRAWINGS

FIG. 1 is an axial cross-sectional view of a hermetically sealed battery according to an embodiment of the present disclosure.

FIG. 2 is a perspective view of an electrode assembly.

FIG. 3 is a cross-sectional view of a sealing plate before press machining.

FIG. 4 is a bottom view of the hermetically sealed battery illustrated in FIG. 1.

### DESCRIPTION OF EMBODIMENTS

Hereinafter, an embodiment of a hermetically sealed battery according to the present disclosure will be described in detail with reference to the drawings. The hermetically sealed battery of the present disclosure may be a primary battery or a secondary battery. In addition, the battery may be a battery using an aqueous electrolyte or a battery using a non-aqueous electrolyte. Hereinafter, as a hermetically sealed battery 10 according to an embodiment, a non-aqueous electrolyte secondary battery using a non-aqueous electrolyte is exemplified, but the hermetically sealed battery of the present disclosure is not limited thereto.

In the following, in a case where a plurality of embodiments, modifications, and the like are included, it is assumed from the beginning to construct a new embodiment by appropriately combining these characteristic portions. In the following embodiments, the same components are denoted by the same reference numerals in the drawings, and redundant description will be omitted. In addition, a plurality of drawings include schematic views, and dimensional ratios such as a length, a width, and a height of each member do not necessarily coincide between different drawings. In the present specification, a sealing assembly 17 side in an axial direction (height direction) of a battery case 15 is referred to as “upper”, and a bottom 68 side of the exterior can 16 in the axial direction is referred to as “lower”. Further, among the constituent elements described below, constituent elements that are not described in independent claims indicating the highest concept are arbitrary constituent elements and are not essential constituent elements.

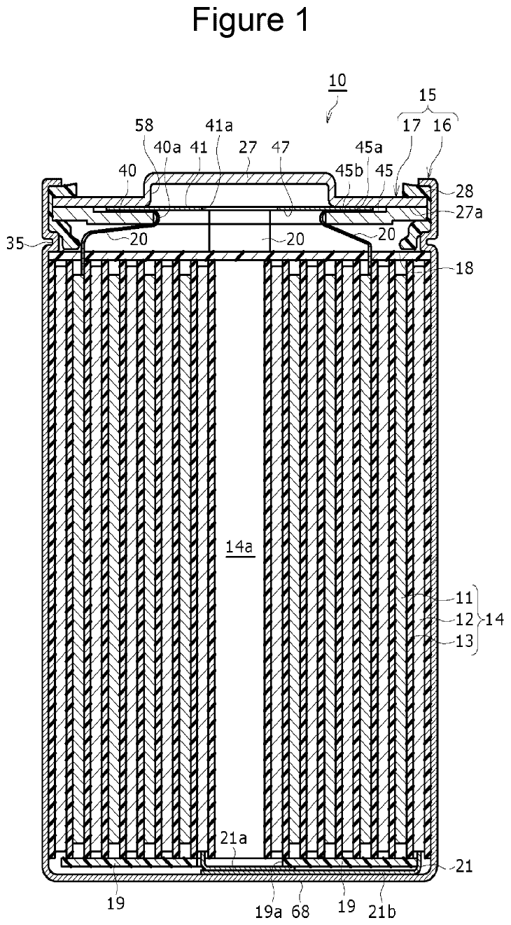

FIG. 1 is an axial cross-sectional view of a hermetically sealed battery according to an embodiment of the present disclosure. As illustrated in FIG. 1, the hermetically sealed battery 10 includes a wound electrode assembly 14, a non-aqueous electrolyte (not illustrated), and the battery case 15 constituted by an exterior can 16 and the sealing assembly 17 that accommodate the electrode assembly 14 and the non-aqueous electrolyte. The hermetically sealed battery 10 illustrated in FIG. 1 includes an insulating plate 18 disposed on an upper side of the electrode assembly 14 and an insulating plate 19 disposed on a lower side of the electrode assembly 14.

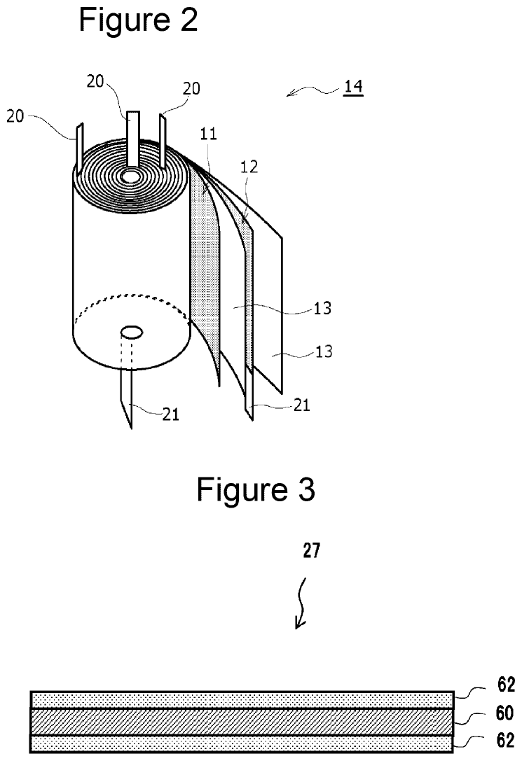

FIG. 2 is a perspective view of the electrode assembly. The electrode assembly 14 illustrated in FIG. 2 is a wound electrode assembly which includes an elongated positive electrode 11, an elongated negative electrode 12, and two elongated separators 13, and in which the positive electrode 11 and the negative electrode 12 are wound with the separator 13 interposed therebetween. Three positive electrode leads 20 are joined to the positive electrode 11, and two negative electrode leads 21 are joined to the negative electrode 12. In order to suppress precipitation of lithium, the negative electrode 12 is desirably formed to have a size slightly larger than that of the positive electrode 11, and is desirably formed to be longer than that of the positive electrode 11 in a longitudinal direction and a width direction (lateral direction). Further, it is desirable that the two separators 13 are formed to have a size slightly larger than at least the positive electrode 11, and are disposed so as to sandwich the positive electrode 11. The electrode assembly 14 is not limited to the wound type, and other forms of electrode assembly such as a laminated electrode assembly in which the positive electrode 11 and the negative electrode 12 are alternately laminated with the separator 13 interposed therebetween may be applied. An outer shape of battery case 15 illustrated in FIG. 1 is cylindrical, but is not limited thereto, and may be rectangular or the like.

The sealing assembly 17 includes a sealing plate 27, a current collector plate 40, and a metal plate 41. The sealing assembly 17 has a structure in which the current collector plate 40, the metal plate 41, and the sealing plate 27 are laminated in this order from an electrode assembly 14 side. The current collector plate 40 is an annular metal plate member, and has a through hole 40a at the central portion in the radial direction. The sealing plate 27 is a metal plate member having no through hole, and closes an opening of the exterior can 16. A configuration of the sealing plate 27 will be described later in detail. The metal plate 41 is an annular metal plate member, and has a through hole 41a at a central portion in the radial direction.

As illustrated in FIG. 1, an outer peripheral portion of the current collector plate 40 is in contact with the sealing plate 27. The outer peripheral portion of the current collector plate 40 is preferably joined to the sealing plate 27 by laser welding or the like. The annular upper surface 45 of the current collector plate 40 has an annular recess 45a on the radially inner side of the outer peripheral portion. The bottom surface 45b of the recess 45a expands in a direction substantially orthogonal to the axial direction.

FIG. 3 is a cross-sectional view of the sealing plate before press machining. As illustrated in FIG. 3, the sealing plate 27 includes a base material 60 and coating layers 62 formed on both surfaces of the base material 60. The sealing plate 27 illustrated in FIG. 3 is pressed to be formed into, for example, as illustrated in FIG. 1, the sealing plate 27 having a protrusion in which a central portion bulges so as to protrude outward from the battery.

The base material 60 is a base material containing Fe as a main component. The main component means a component having the largest content among the components constituting the base material 60. As the base material 60 containing Fe as a main component, a stainless steel base material is preferably used from the viewpoint of mechanical strength, corrosion resistance to a non-aqueous electrolyte, and the like. The thickness of the base material 60 is not particularly limited, but is preferably, for example, greater than or equal to 0.8 mm from the viewpoint of mechanical strength and the like.

In the sealing plate 27 illustrated in FIG. 3, the coating layer 62 is formed on both surfaces of the base material 60, but may be formed on one surface. However, when the coating layer 62 is formed only on one surface of the base material 60, it is necessary to attach the sealing plate 27 to the exterior can 16 such that the coating layer 62 formed on one surface of the base material 60 is disposed inside the battery. That is, the coating layer 62 may be formed on at least one surface serving as the battery inner surface of both surfaces of the base material 60.

The coating layer 62 is a layer containing Al and Si. Al and Si exist, for example, as a solid solution alloy or an intermetallic compound. The presence of Si in the coating layer 62 can improve the adhesion strength with the base material 60 as compared with an Al coating layer not containing Si. As a result, when the sealing plate 27 is pressed into a predetermined shape, cracking of an interface between the base material 60 and the coating layer 62 and exposure of the base material 60 from a cracked portion are suppressed, and therefore, for example, corrosion of the base material 60 due to a non-aqueous electrolyte inside a battery is suppressed.

The content of Si in the coating layer 62 is, for example, preferably in a range greater than or equal to 1% by mass and less than or equal to 20% by mass, and more preferably in a range greater than or equal to 5% by mass and less than or equal to 15% by mass from the viewpoint of further improving the adhesion strength with the base material 60. The content of Al in the coating layer 62 is, for example, preferably greater than or equal to 80 mass %, and more preferably greater than or equal to 90 mass %. The coating layer 62 may contain impurity elements other than Si and Al. The content of impurity elements in the coating layer 62 is preferably, for example, less than or equal to 1% by mass.

A compound containing Fe, Si, and Al is preferably interposed at the interface between the base material 60 and the coating layer 62. As a result, the adhesion strength between the base material 60 and the coating layer 62 can be further improved. The compound containing Fe, Si, and Al may be present so as to cover the interface between the base material 60 and the coating layer 62, or may be present dispersed in an island shape at the interface between the base material 60 and the coating layer 62. The compound containing Fe, Si, and Al is, for example, a solid solution alloy or an intermetallic compound containing three kinds of Fe, Si, and Al as main components.

Each element constituting the coating layer 62 and each element of the compound present at the interface between the base material 60 and the coating layer 62 can be detected by analysis using, for example, an X-ray photoelectron spectrometer or an X-ray diffractometer.

Examples of the method for forming the coating layer 62 include physical vapor deposition (PVD) such as a vacuum vapor deposition method, a sputtering method, and an ion plating method, chemical vapor deposition (CVD) such as thermal CVD and atomic layer deposition (ALD), and a plating method (electroplating, electroless plating, hot-dip plating, and vacuum plating). After the coating layer 62 is formed by the above method, heat treatment may be performed as necessary. Among them, the hot-dip plating method is preferable in that the coating layer 62 is easily formed. In addition, according to the hot-dip plating method, a compound containing Fe, Si, and Al can be formed at the interface between the base material 60 and the coating layer 62 together with the formation of the coating layer 62. In the case of a method other than the hot-dip plating method, it may be necessary to perform a heat treatment in order to form a compound containing Fe, Si, and Al at the interface between the base material 60 and the coating layer 62 after forming the coating layer 62.

Examples of the formation of the coating layer 62 by the hot-dip plating method include a dovetail method in which the base material 60 is immersed in a hot-dip plating bath containing Al and Si and then pulled up. A temperature of the hot-dip plating bath is preferably, for example, in a range greater than or equal to 500 and less than or equal to 700° C. An adhesion amount of the coating layer 62 is preferably, for example, in a range greater than or equal to 40 and less than or equal to 100 g/m².

The exterior can 16 illustrated in FIG. 1 is a bottomed cylindrical metal exterior can having an opening. The exterior can 16 has an annular groove portion 35 in a part of the cylindrical outer peripheral surface in the axial direction. The groove portion 35 can be formed, for example, by spinning a part of the cylindrical outer peripheral surface radially inward to be recessed radially inward. The sealing plate 27 and the current collector plate 40 constituting the sealing assembly 17 are disposed on the groove portion 35, and fixed to the opening of the exterior can 16 by caulking via the gasket 28, so that the internal space of the battery case 15 is sealed. The gasket 28 serves not only as a sealing material for maintaining airtightness inside the battery but also as an insulating material for insulating the exterior can 16 and the sealing assembly 17 from each other. The outer shape of exterior can 16 is not limited to the bottomed cylindrical shape, and may be, for example, a bottomed rectangular cylindrical shape.

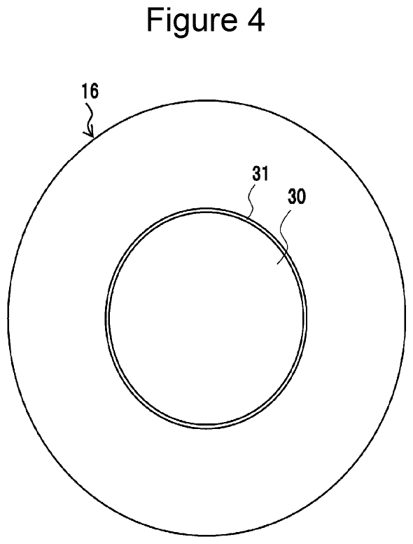

FIG. 4 is a bottom view of the hermetically sealed battery illustrated in FIG. 1, and is a view of the bottom of the exterior can illustrated in FIG. 1 as viewed from the outside of the hermetically sealed battery. As illustrated in FIG. 4, the bottom of the exterior can 16 is provided with a gas discharge portion 30 that opens when an internal pressure of the battery reaches a predetermined pressure. Specifically, a groove 31 is formed in the bottom of the exterior can 16, and a portion surrounded by the groove 31 is the gas discharge portion 30.

The groove 31 is, for example, an engraved mark formed from an outer surface side of the bottom of the exterior can 16, and a portion where the groove is formed in the bottom of the exterior can 16 is a thin portion having a smaller thickness than other portions. When the internal pressure of the battery reaches a predetermined pressure, the thin portion is broken, and the gas discharge portion 30 is opened. A plan view shape of the gas discharge portion 30 illustrated in FIG. 4 is a circular shape, but is not limited thereto, and may be a semicircular shape, a polygonal shape, or the like.

The positive electrode 11 includes, for example, a positive electrode current collector and a positive electrode mixture layer formed on both surfaces of the positive electrode current collector. As the positive electrode current collector, for example, a metal foil, such as aluminum or an aluminum alloy, which is stable in a potential range of the positive electrode 11, a film in which the metal is disposed on a surface layer, or the like can be used. The positive electrode mixture layer contains, for example, a positive electrode active material, a conductive agent, and a binder. The positive electrode 11 can be produced, for example, by applying a positive electrode mixture slurry containing a positive electrode active material, a conductive agent, a binder, and the like onto a positive electrode current collector, drying a coating film, and then performing compression to form a positive electrode mixture layer on both surfaces of the positive electrode current collector.

The positive electrode active material is, for example, a lithium-containing metal composite oxide capable of reversibly inserting and removing lithium. Examples of the metal element contained in the lithium-containing metal composite oxide include Ni, Co, Mn, Al, B, Mg, Ti, V, Cr, Fe, Cu, Zn, Ga, Sr, Zr, Nb, In, Sn, Ta, and W. An example of a preferred lithium-containing metal composite oxide is a composite oxide containing at least one of Ni, Co, Mn, and Al.

Examples of the conductive agent contained in the positive electrode mixture layer include carbon materials such as carbon black, acetylene black, Ketjenblack, and graphite. Examples of the binder contained in the positive electrode mixture layer include fluororesins such as polytetrafluoroethylene (PTFE) and polyvinylidene fluoride (PVdF), polyacrylonitrile (PAN), polyimide resins, acrylic resins, polyolefin resins, styrene-butadiene rubber (SBR) or a modified product thereof, cellulose derivatives such as carboxymethyl cellulose (CMC) or a salt thereof, polyacrylic acid (PAA) or a salt thereof, polyvinyl alcohol, and polyethylene oxide (PEO).

The negative electrode 12 includes, for example, a negative electrode current collector and negative electrode mixture layers formed on both surfaces of the negative electrode current collector. As the negative electrode current collector, for example, a metal foil, such as copper or a copper alloy, which is stable in a potential range of the negative electrode 12, a film in which the metal is disposed on a surface layer, or the like can be used. The negative electrode mixture layer contains, for example, a negative electrode active material and a binder. The negative electrode 12 can be produced, for example, by applying a negative electrode mixture slurry containing a negative electrode active material, a binder, and the like onto a negative electrode current collector, drying a coating film, and then performing compression to form negative electrode mixture layers on both surfaces of the current collector.

The negative electrode active material can reversibly store and release lithium ions, and examples thereof include a carbon material, a metal alloyed with lithium such as silicon (Si) or tin (Sn), an alloy containing the metal, a compound containing the metal, and the like. As the carbon material, for example, natural graphite such as scale-like graphite, massive graphite, and earthy graphite, and artificial graphite such as massive artificial graphite and graphitized mesophase carbon microbeads are preferable.

As in the case of the positive electrode 11, the binder contained in the negative electrode mixture layer may be a fluororesin, PAN, a polyimide resin, an acrylic resin, a polyolefin resin, SBR or a modified product thereof, a cellulose derivative such as CMC or a salt thereof, PAA or a salt thereof, polyvinyl alcohol, PEO, or the like.

As the separator 13, for example, a porous sheet having ion permeability and insulating properties is used. Specific examples of the porous sheet include a microporous thin film, a woven fabric, and a nonwoven fabric. The material of the separator 13 is preferably a polyolefin resin such as polyethylene or polypropylene, cellulose, or the like. The separator 13 may have either a single layer structure or a laminated structure. A heat resistant layer or the like may be formed on the surface of the separator 13.

As illustrated in FIG. 1, the positive electrode lead 20 attached to the positive electrode 11 extends toward the sealing assembly 17 through the through hole of the insulating plate 18, and is bent along the bottom surface 45b of the recess 45a of the current collector plate 40 through the through hole 40a of the current collector plate 40. A tip of the positive electrode lead 20 is sandwiched between the bottom surface 45b of the recess 45a of the current collector plate 40 and the lower surface 47 of the metal plate 41. The positive electrode lead 20 is joined to the bottom surface 45b of the recess 45a of the current collector plate 40. The current collector plate 40 and the metal plate 41 are also joined, and the positive electrode lead 20 and the metal plate 41 are also joined. Such joining can be realized, for example, by laser welding from the side opposite to the current collector plate 40 side in the thickness direction of the metal plate 41 in a state where the tip of the positive electrode lead 20 is sandwiched between the current collector plate 40 and the metal plate 41. The current collector plate 40 may not be joined to the metal plate 41, and the positive electrode lead 20 may not be joined to the metal plate 41.

As illustrated in FIG. 1, the first negative electrode lead 21a joined to an end of the negative electrode 12 on a winding start side is bent toward the hollow portion 14a of the electrode assembly 14 through the through hole 19a of the insulating plate 19. The second negative electrode lead 21b joined to an end of the negative electrode 12 on a winding end side passes through the outside of the insulating plate 19 and is bent so as to overlap the first negative electrode lead 21a. The overlapping portion of the first negative electrode lead 21a and the second negative electrode lead 21b is joined to the inner surface of the bottom 68 of the exterior can 16 by resistance welding using a welding rod inserted into the hollow portion 14a of the electrode assembly 14.

In the hermetically sealed battery 10, the sealing plate 27 electrically connected to the positive electrode lead 20 serves as a positive electrode terminal, and the exterior can 16 electrically connected to the negative electrode lead 21 serves as a negative electrode terminal.

The non-aqueous electrolyte contains a non-aqueous solvent and an electrolyte salt dissolved in the non-aqueous solvent. As the non-aqueous solvent, for example, esters, ethers, nitriles, amides, mixed solvents of two or more thereof, and the like may be used. The non-aqueous solvent may contain a halogen-substituted product obtained by substituting at least a part of hydrogen atoms of these solvents with a halogen atom such as fluorine. The non-aqueous electrolyte is not limited to the liquid electrolyte, and may be a solid electrolyte using a gel polymer or the like. As the electrolyte salt, a lithium salt such as LiPF₆ is used.

### Embodiment

A base material made of stainless steel (chromium: 17 mass %) was immersed in a hot-dip plating bath containing Al and Si, then pulled up, and rapidly cooled to prepare a plate member having coating layers containing Al and Si formed on both surfaces of the base material. The adhesion amount of the coating layer was 40 g/m².

The obtained plate member was pressed to produce a sealing plate having a protrusion at the central portion as illustrated in FIG. 1. When the obtained sealing plate was magnified and observed with a microscope, interface cracking between the base material and the coating layer and exposure of the base material were not observed at any position.

### REFERENCE SIGNS LIST

10 Hermetically sealed battery
11 Positive electrode
12 Negative electrode
13 Separator
14 Electrode assembly
14a Hollow portion
15 Battery case
16 Exterior can
17 Sealing assembly
18, 19 Insulating plate
20 Positive electrode lead
21 Negative electrode lead
27 Sealing plate
28 Gasket
30 Gas discharge portion
31 Groove
35 Groove portion
40 Current collector plate
41 Metal plate
60 Base material
62 Coating layer

1. A hermetically sealed battery comprising:
a bottomed cylindrical exterior can that has an opening and accommodates an electrode assembly and an electrolyte; and
a sealing plate that closes the opening of the exterior can,
wherein the sealing plate includes a base material containing Fe as a main component and a coating layer containing Al and Si and formed on a battery inner surface of the base material.

2. The hermetically sealed battery according to claim 1, wherein a compound containing Fe, Si, and Al is interposed at an interface between the base material and the coating layer.

3. The hermetically sealed battery according to claim 1, wherein the base material is made of stainless steel.

4. The hermetically sealed battery according to claim 1, wherein a gas discharge portion that opens when an internal pressure of the battery reaches a predetermined pressure is formed at a bottom of the exterior can.
